(19) United States
(12) Patent Application Publication
(10) Pub. No.: US 2026/0295604 A1
(43) Pub. Date: Oct. 1, 2026

(54) CLEANER

(71) Applicant: LG ELECTRONICS INC., Seoul (KR)

(72) Inventors: Kietak HYUN, Seoul (KR); Jaehun HAN, Seoul (KR); Inkyu HWANG, Seoul (KR); Junhyung LIM, Seoul (KR)

(73) Assignee: LG ELECTRONICS INC., Seoul (KR)

(21) Appl. No.: 19/474,042

(22) PCT Filed: Mar. 13, 2024
(86) PCT No.: PCT/KR2024/095486

§ 371 Date: Oct. 9, 2025

(30) Foreign Application Priority Data
Apr. 24, 2023 (KR) 10-2023-0053470

(51) Int. Cl. B04C 5/26; A47L 9/16; B04C 5/103; B04C 5/185; B04C 9/00

(52) U.S. Cl. CPC B04C 5/26; A47L 9/1608; A47L 9/1625; A47L 9/1666; A47L 9/1683; B04C 5/103; B04C 5/185; B04C 9/00; B04C 2009/004; B04C 2009/007

(57) ABSTRACT

The present disclosure relates to a cleaner including: a suction part; a dust separating part configured to separate dust from air sucked through the suction part; and a suction motor configured to provide a flow force of air, in which the dust separating part includes: a first cyclone part; and a second cyclone part, and in which the second cyclone part includes: a cylinder disposed in the housing and having a guide vane configured to induce a swirling flow in the air; a separation wall disposed between the cylinder and the suction motor in a direction intersecting the cylinder; and a discharge member protruding from the separation wall, disposed in the cylinder, and formed to discharge the air, thereby providing a simple structure.

### TECHNICAL FIELD

The present disclosure relates to a cleaner, and more particularly, to a cleaner in which a dust separating part configured to separate dust from sucked air has a simple structure.

### BACKGROUND ART

A cleaner refers to a device that cleans a target cleaning region by sucking dust or debris or wiping the target cleaning region.

In order to provide driving power for sucking dust, the cleaner includes an impeller, and a motor configured to rotate the impeller. The cleaner generates a suction force by reducing internal pressure by discharging inside air to the outside by operating the motor. The suction force, which is generated in this manner, sucks debris, such as dust, on a cleaning surface together with outside air by means of a suction means, and the outside air and the sucked debris may be removed by a dust collecting device or the like.

Depending on the shape of the cleaner, the cleaners may be classified into a canister cleaner, an upright cleaner, a handy cleaner, a stick cleaner, and the like.

A wireless vacuum cleaner uses a multi-cyclone dust collecting device, which uses a centrifugal force, as the dust collecting device for collecting dust and dirt.

The multi-cyclone dust collecting device includes a primary cyclone part configured to separate and collect dirt and dust from dirt-containing air introduced from the outside, and a plurality of secondary cyclone parts configured to separate fine dust from the air discharged from the primary cyclone part.

Meanwhile, Korean Patent No. KR2080013B discloses a vacuum cleaner having a multi-cyclone part.

The vacuum cleaner has a plurality of inlet ports formed outside a body of the cyclone part. Therefore, a cyclone flow may be generated as air is introduced in a tangential direction of the cyclone part.

However, in the case of the vacuum cleaner, the cyclone flow is generated outside the cyclone part. For this reason, there is a limitation in that a rotational force of air is low and dust separation performance deteriorates in comparison with an axial-flow type cleaner having a vane for inducing a cyclone flow on an inner peripheral surface of the cyclone part.

In addition, the multi-cyclone part has a limitation in that the areas of the inlet and outlet ports are decreased, and the efficiency of the cyclone part is degraded.

### DISCLOSURE

### Technical Problem

The present disclosure has been made in an effort to solve the above-mentioned problem of the cleaner in the related art, and an object of the present disclosure is to provide a cleaner in which a second cyclone part is provided as a single cyclone structure to which a single cyclone is applied.

In addition, an object of the present disclosure is to provide a cleaner that improves dust separation efficiency by increasing a cyclone length in a single cyclone structure. In particular, an object of the present disclosure is to provide a cleaner that induces air to rotate while performing a U-turn, thereby increasing a residence time and a cyclone length when the air flows.

In addition, an object of the present disclosure is to provide a cleaner capable of increasing a cross-sectional area of an inlet port and a cross-sectional area of a discharge port to improve cyclone efficiency and decreasing a flow velocity to reduce a flow loss.

In addition, an object of the present disclosure is to provide a cleaner in which a space is provided between an inlet port and an outlet port to prevent a problem in which air directly flows through the outlet port immediately after the air is introduced and dust is discharged to the outside, thereby improving dust separation efficiency.

The objects of the present disclosure are not limited to the aforementioned objects, and other objects, which are not mentioned above, may be clearly understood from the following descriptions.

### Technical Solution

In order to achieve the above-mentioned objects, a cleaner according to the present disclosure may include: a suction part having a flow path through which air flows; a dust separating part configured to separate dust from air sucked through the suction part; and a suction motor configured to provide a flow force of air, in which the dust separating part includes: a first cyclone part configured to separate debris from air sucked into the suction part; and a second cyclone part configured to separate debris from air passing through the first cyclone part, in which the first cyclone part includes a cylindrical housing in which a mesh filter is installed to allow the air to flow to the second cyclone part, and in which the second cyclone part includes: a cylinder disposed in the housing and having a guide vane configured to induce a swirling flow in the air; a separation wall disposed between the cylinder and the suction motor in a direction intersecting the cylinder; and a discharge member protruding from the separation wall, disposed in the cylinder, and formed to discharge the air.

The second cyclone part may include: a first flow path through which air flows toward the suction motor; a second flow path through which air having passed through the first flow path flows to a side opposite to the suction motor; and a third flow path through which air having passed through the second flow path toward the suction motor.

The second cyclone part may have an inlet portion disposed between the housing and the cylinder and configured to allow the air to flow toward the suction motor.

The guide vane may protrude in a spiral shape from an outer peripheral surface of the cylinder and be installed in the inlet portion, and the guide vane may be disposed adjacent to an end of the cylinder adjacent to the suction motor.

The second cyclone part may have an inlet portion configured to allow the air in the cylinder to flow toward the suction motor, and the cylinder may have a sub-filter connected to the separation wall and configured to introduce the air having passed through the mesh filter into the cylinder.

The guide vane may protrude in a spiral shape from an inner peripheral surface of the cylinder and be installed in the inlet portion, and an end of the guide vane adjacent to the suction motor may be disposed to be spaced apart from an end of the discharge member opposite to the suction motor along a central axis of a secondary cyclone flow.

The sub-filter may be formed in a cylindrical shape and disposed with a hollow guide space interposed between the sub-filter and the mesh filter.

A hollow separation space may be provided between the cylinder and the discharge member.

The dust separating part may further include: an outer casing connected to the suction part and configured such that the housing is disposed in the outer casing, the outer casing being configured to provide a dust collecting portion configured to store dust separated from the air; and a discharge cover configured to open or close a lower side of the outer casing, a lower end of the cylinder may have a tapered portion formed to be spaced apart from the discharge cover, and the discharge cover may have a rib protruding toward the cylinder and configured to surround a lower end of the tapered portion.

Meanwhile, a cleaner according to the embodiment of the present disclosure may include: a suction part having a flow path through which air flows; a dust separating part configured to separate dust from air sucked through the suction part; and a suction motor configured to provide a flow force of air, in which the dust separating part includes: a first cyclone part configured to separate debris from air sucked into the suction part; and a second cyclone part configured to separate debris from air passing through the first cyclone part, and in which the second cyclone part includes: a first flow path through which air flows toward the suction motor; a second flow path through which air having passed through the first flow path flows to a side opposite to the suction motor; and a third flow path through which air having passed through the second flow path toward the suction motor.

Meanwhile, a cleaner according to the embodiment of the present disclosure may include: a suction part having a flow path through which air flows; a dust separating part configured to separate dust from air sucked through the suction part; and a suction motor configured to provide a flow force of air, in which the dust separating part includes: a first cyclone part configured to separate debris from air sucked into the suction part; and a second cyclone part configured to separate debris from air passing through the first cyclone part, in which the dust separating part has a mesh filter and a sub-filter disposed to be spaced apart from each other with a hollow guide space therebetween, and in which the air passes through the mesh filter and the sub-filter and flows to the second cyclone part.

### Advantageous Effects

The cleaner of the present disclosure described above has one or more of the following effects.

According to the cleaner according to the present disclosure, the second cyclone part is provided as the single cyclone structure to which the single cyclone is applied, such that the cleaner has a simple structure and is easy to assemble and manufacture.

In addition, it is possible to improve the dust separation efficiency by increasing the cyclone length in the single cyclone structure. In particular, the air may be guided upward from the inlet port and perform a U-turn, thereby increasing the residence time and the cyclone length when the air flows.

In addition, the guide vane may be disposed outside the cylinder, or the guide vane is disposed to be spaced apart from the discharge member in the axial direction, thereby increasing the cross-sectional areas of the inlet and discharge ports. Further, the cross-sectional areas of the inlet and discharge ports may be increased to improve the cyclone efficiency, and a flow velocity may be decreased to reduce a flow loss.

In addition, the space is disposed between the inlet port and the discharge port spaced apart from each other, thereby improving the dust separation performance by solving a problem in which the air directly flows to the discharge port, immediately after the air is introduced, and dust is discharged to the outside together with the air without being separated.

### DESCRIPTION OF DRAWINGS

FIG. 1 is a schematic view of a cleaner according to an embodiment of the present disclosure.

FIG. 2 is a perspective view illustrating a cleaner main body according to the embodiment of the present disclosure.

FIG. 3 is a cross-sectional view for explaining a flow of air in the cleaner according to the embodiment of the present disclosure.

FIG. 4 is an enlarged cross-sectional view of a dust separating part in FIG. 3.

FIG. 5 is a cross-sectional view illustrating an airflow and a dust flow in FIG. 4.

FIG. 6 is a cross-sectional view taken along line 6-6 in FIG. 3.

FIG. 7 is an enlarged view of a part of FIG. 3.

FIG. 8 is a cross-sectional view of a cleaner according to another embodiment of the present disclosure.

FIG. 9 is a cross-sectional view illustrating an airflow and a dust flow in FIG. 8.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

Hereinafter, a cleaner according to the present specification will be described with reference to the accompanying drawings.

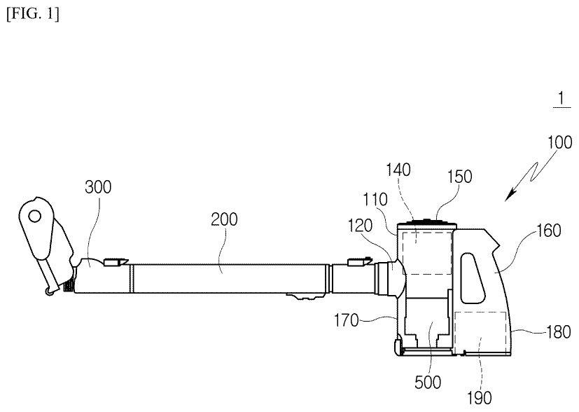

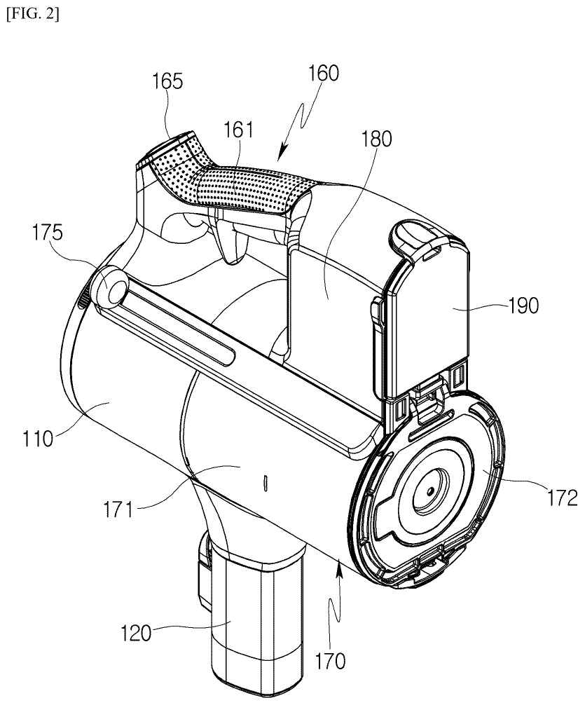

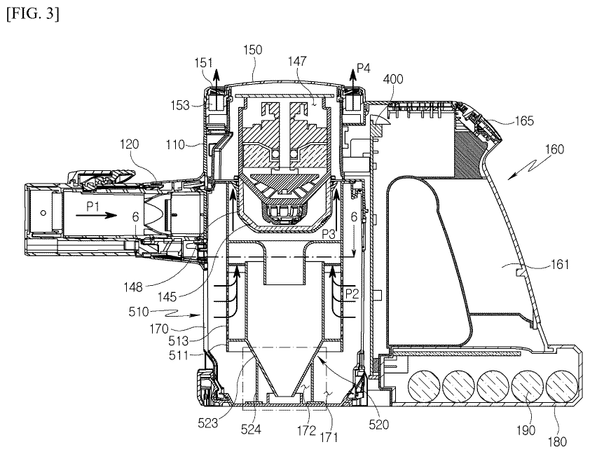

FIG. 1 is a schematic view of a cleaner according to an embodiment of the present disclosure, FIG. 2 is a perspective view illustrating a cleaner main body according to the embodiment of the present disclosure, and FIG. 3 is a cross-sectional view for explaining a flow of air in the cleaner according to the embodiment of the present disclosure.

Meanwhile, the term “cleaning target” used in the present specification may refer to not only a floor surface of a room such as a living room but also a cleaning surface such as a carpet.

With reference to FIGS. 1 to 3, a cleaner 1 according to an embodiment of the present disclosure may include a cleaner main body 100 having a suction motor 140 configured to generate a suction force, a suction module 300 connected to the cleaner main body 100 and configured to suck air and debris on the cleaning target, and an extension tube 200 configured to connect the cleaner main body 100 and the suction module 300.

A structure of the cleaner main body 100 will be described below.

Meanwhile, in the embodiment of the present disclosure, directions may be defined on the basis of when a lower surface of an outer casing 170 and a lower surface of a battery housing 180 are placed on a ground surface.

In this case, a forward direction may refer to a direction in which a suction part 120 is disposed based on the suction motor 140, and a rearward direction may refer to a direction in which a handle 160 is disposed based on the suction motor 140. Further, based on a state in which the suction part 120 is viewed from the suction motor 140, a rightward direction may refer to a direction in which a component is disposed at the right side, and a leftward direction may refer to a direction in which a component is disposed at the left side. In addition, in the embodiment of the present disclosure, upper and lower sides may be defined in a direction perpendicular to the ground surface based on the state in which the bottom surface (lower surface) of the outer casing 170 and the bottom surface (lower surface) of the battery housing 180 are placed on the ground surface.

The cleaner 1 may include the cleaner main body 100. A flow path may be formed in the cleaner main body 100 and guide the sucked air so that the air is discharged to the outside.

Specifically, the cleaner main body 100 may include a main body housing 110, the suction part 120, a dust separating part 500, the suction motor 140, an air discharge cover 150, the handle 160, the outer casing 170, the battery housing 180, and a battery 190.

The main body housing 110 may define an external appearance of the cleaner main body 100. The main body housing 110 may provide a space that may accommodate the suction motor 140 and a prefilter 145. For example, the main body housing 110 may be formed in a shape similar to a cylindrical shape.

The suction part 120 may protrude outward from the main body housing 110. For example, the suction part 120 may be formed in a cylindrical shape with an opened inside. The suction part 120 may be coupled to an extension tube 200. The suction part 120 may provide a flow path P1 in which air containing dust may flow.

The dust separating part 500 may communicate with the suction part 120. The dust separating part 500 adopts a principle of a dust collector using a centrifugal force to separate the dust sucked into the cleaner main body 100 through the suction part 120. A space in the dust separating part 500 may communicate with a space in the outer casing 170.

For example, the dust separating part 500 may include the outer casing 170 and have first and second cyclone parts 510 and 520 capable of separating dust by means of a cyclone flow. Further, the space in the dust separating part 500 may communicate with the flow path P1 formed in the suction part 120. Therefore, air and dust, which are sucked through the suction part 120, spirally flow along an outer circumferential surface of the dust separating part 500. Therefore, the cyclone flow may be generated in the internal space of the dust separating part 500.

The specific configuration and effect of the dust separating part 500 will be described below in detail.

The suction motor 140 may be disposed in the flow path and generate a flow force for moving the air in the flow path.

The suction motor 140 may have an impeller 141. A shaft of the suction motor 140 may be inserted into a center of the impeller 141 in an upward/downward direction. In this case, the shaft of the suction motor 140 may be fixed to the center of the impeller 141. With this configuration, when the suction motor 140 operates, the impeller 141 may rotate together with the shaft of the suction motor 140 and generate the flow force for the air.

For example, the suction motor 140 may include an annular stator, the shaft configured to penetrate the center of the stator, and a rotor axially installed on the shaft and configured to generate a rotational force together with the stator. Meanwhile, in the present embodiment, a brushless direct current motor (BLDC motor) is used as the suction motor 140. However, the present disclosure is not limited thereto. Various types of motors may be applied.

The suction motor 140 may suck air through an air suction port 146 provided in an upper central portion of a housing of the suction motor 140 and discharge the air through an air discharge port 147 provided in a circumferential direction at a lower side of the suction motor 140. With this configuration, the air flowing in the suction motor 140 may effectively dissipate heat generated by the suction motor 140.

The cleaner 1 may include the prefilter 145 configured to filter the air before the air is sucked into the suction motor 140. For example, the prefilter 145 may be disposed to surround the impeller 141. For example, the air in a suction flow path P3 may pass through the prefilter 145 and reach the impeller 141. The prefilter 145 may be disposed in the cleaner main body 100. The prefilter 145 may be disposed below the air discharge cover 150. A user may separate the air discharge cover 150 from the main body housing 110 and withdraw the prefilter 145 from the inside of the cleaner main body 100.

The cleaner main body 100 may include an air guide 148 configured to guide the air discharged from the dust separating part 500. The air guide 148 may be disposed between the main body housing 110 and the housing of the suction motor 140. The air guide 148 may define the suction flow path P3 configured to guide the air from the dust separating part 500 to the impeller 141. The air guide 148 may define an air discharge flow path P4 configured to guide the air, which has passed through the impeller 141, to an air discharge port 151.

With this configuration, the air guide 148 may define the flow paths P3 and P4 so that the air discharged from the dust separating part 500 ascends, descends while passing through the impeller 141, and then ascends again to the air discharge port 151.

Therefore, for example, the air and dust, which are sucked through the flow path P1 in the suction part 120 by the operation of the suction motor 140, may be separated from each other while flowing through a flow path P2 in the dust separating part 500. The air, from which dust is separated by the dust separating part 130, may flow upward and be introduced into the suction flow path P3 in a fan driving part. The suction flow path P3 may guide the air toward the prefilter 145. The air sequentially passing through the prefilter 145 and the impeller 141 may be introduced into the air discharge flow path P4 and discharged to the outside through the air discharge port 151 after passing through a HEPA filter 153.

In this case, the suction flow path P3 in the fan driving part may be connected to the flow path P2 in the dust separating part 500, and the air having passed through the dust separating part 500 may flow through the suction flow path P3. The suction flow path P3 in the fan driving part may be formed such that the air having passed through the dust separating part 500 flows to the impeller 141.

Meanwhile, the cleaner 1 according to the embodiment of the present disclosure may include a printed circuit board (PCB) 400 configured to control the suction motor 140. The printed circuit board 400 may be disposed between the suction motor 140 and the dust separating part 500. Alternatively, as illustrated, the printed circuit board 400 may be disposed in a space between the main body housing 110 and the handle 160.

The air discharge cover 150 may define an external appearance of an upper side of the cleaner main body 100 and cover an upper side of the suction motor 140.

The air discharge cover 150 may be disposed at one side of the main body housing 110 based on an axial direction.

The air discharge port 151, through which the air in the flow path is discharged to the outside of the cleaner main body 100, may be formed in the air discharge cover 150.

For example, the air discharge port 151 may be disposed to be directed in a particular direction. For example, the plurality of air discharge ports 151 may be divided in the circumferential direction. The plurality of air discharge ports 151 may be arranged to be spaced apart from one another at predetermined intervals in the circumferential direction.

The air discharge cover 150 may accommodate a filter configured to filter the air before the air is discharged to the air discharge port 151. For example, the air discharge cover 150 may accommodate the HEPA filter 153.

The air having passed through the suction motor 140 may pass through the HEPA filter 153 and then be discharged to the outside through the air discharge port 151. The HEPA filter 153 may be disposed in the air discharge flow path P4.

The air discharge cover 150 may have a filter accommodation space for accommodating the HEPA filter 153. The filter accommodation space may be formed to be opened at a lower side thereof, and the HEPA filter 153 may be accommodated at the lower side of the air discharge cover 150.

The air discharge port 151 may be formed to face the HEPA filter 153. For example, the HEPA filter 153 may be disposed below the air discharge port 151. For example, the HEPA filter 153 may be disposed to extend in the circumferential direction along the air discharge port 151.

The handle 160 may be gripped by the user. The handle 160 may be disposed rearward of the suction motor 140. For example, the handle 160 may be formed in a shape similar to a cylindrical shape. Alternatively, the handle 160 may be formed in a curved cylindrical shape. The handle 160 may be disposed at a predetermined angle with respect to the main body housing 110, the suction motor 140, or the dust separating part 130.

The handle 160 may include a grip portion 161 formed in a column shape so that the user may grasp the grip portion 161, a first extension portion connected to one end of the grip portion 161 based on the longitudinal direction (axial direction) of the grip portion 161 and extending toward the suction motor 140, and a second extension portion connected to the other end of the grip portion 161 based on the longitudinal direction (axial direction) of the grip portion 161 and extending toward the outer casing 170.

An upper side of the handle 160 may define an external appearance of a part of an upper side of the cleaner 1. Therefore, it is possible to prevent a component of the cleaner 1 from coming into contact with the user's arm in case that the user grips the handle 160.

The operating part 165 may be disposed on the handle 160. The operating part 165 may be disposed on an inclined surface formed in an upper region of the handle 160. The user may input a command for operating or stopping the cleaner 1 through the operating part 165.

The outer casing 170 may be disposed at the other side of the main body housing 110 based on the axial direction. That is, the outer casing 170 may be disposed below the main body housing 110. The outer casing 170 may be separably coupled to the main body housing 110 or integrated with the main body housing 110. The dust separating part 500 may be accommodated in the outer casing 170. The outer casing 170 may be included in the dust separating part 500 and communicate with the suction part 120, and a primary cyclone flow may be formed in the outer casing 170.

Further, the outer casing 170 may be a dust bin configured to provide a space for storing dust separated by the dust separating part 500 and have therein a first dust collecting portion 171 and a second dust collecting portion 172.

For example, the outer casing 170 may be formed in a shape similar to a cylindrical shape and configured such that a lower side thereof may be opened. In this case, a discharge cover 173 may be provided at the lower side of the outer casing 170 and selectively open the lower side of the outer casing 170.

The discharge cover 173 may be provided to open or close the lower side of the outer casing 170. The discharge cover 173 may be rotatably coupled to the lower side of the outer casing 170. The discharge cover 173 may be hingedly coupled to the outer casing 170 and open or close the lower side of the outer casing 170 while rotating.

Meanwhile, according to the embodiment, the outer casing 170 may further include a dust bin compression lever 175 and a compression member.

The dust bin compression lever 175 may be disposed outside the outer casing 170 or the dust separating part 500. The dust bin compression lever 175 may be disposed outside the outer casing 170 or the dust separating part 500 so as to be movable upward and downward. The dust bin compression lever 175 may be connected to the compression member. In case that the dust bin compression lever 175 is moved downward by an external force, the compression member may also be moved downward. Therefore, it is possible to provide convenience for the user. The compression member and the dust bin compression lever 175 may return back to original positions by an elastic member (not illustrated). Specifically, in case that the external force applied to the dust bin compression lever 175 is eliminated, the elastic member may move the dust bin compression lever 175 and the compression member upward.

The compression member may be disposed in the outer casing 170. The compression member may move in the internal space of the outer casing 170. Specifically, the compression member may move upward and downward in the outer casing 170. Therefore, the compression member may compress downward the dust in the outer casing 170. In addition, in case that the discharge cover 173 is separated from the outer casing 170 and thus the lower side of the outer casing 170 is opened, the compression member may move from an upper side of the outer casing 170 to the lower side of the outer casing 170, thereby removing debris such as residual dust in the outer casing 170. Therefore, it is possible to improve the suction force of the cleaner by preventing the residual dust from remaining in the outer casing 170. Further, it is possible to remove an offensive odor caused by the residual dust by preventing the residual dust from remaining in the outer casing 170.

The battery 190 may be accommodated in the battery housing 180. The battery housing 180 may be disposed below the handle 160.

For example, the battery housing 180 may have a hexahedral shape opened at a lower side thereof. A rear side of the battery housing 180 may be connected to the handle 160. In this case, the battery housing 180 may include an accommodation portion opened at a lower side thereof. With this configuration, the battery 190 may be attached or detached through the accommodation portion of the battery housing 180.

In another example, the battery housing 180 and the battery 190 may be integrated in a state in which the battery housing 180 accommodates the battery 190.

The battery 190 serves to supply power to the cleaner 1. Specifically, the battery 190 may supply power to the suction motor 140 and supply power to an electronic circuit and an electronic component through electric wires embedded in the cleaner 1. In addition, the battery 190 may supply power to the suction module 300.

In a case in which the battery 190 is coupled to the battery housing 180, a lower side of the battery 190 may be exposed to the outside. Because the battery 190 may be placed on the floor when the cleaner 1 is placed on the floor, the battery 190 may be immediately separated from the battery housing 180. In addition, because the lower side of the battery 190 is exposed to the outside and thus in direct contact with the air present outside the battery 190, the performance in cooling the battery 190 may be improved.

Meanwhile, in case that the battery 190 is fixed integrally to the battery housing 180, the number of structures for attaching or detaching the battery 190 and the battery housing 180 may be reduced, and as a result, it is possible to reduce an overall size of the cleaner 1 and a weight of the cleaner 1.

Meanwhile, the cleaner 1 may include the extension tube 200.

The extension tube 200 may be coupled to the cleaner main body 100 and the suction module 300. One end of the extension tube 200 may be detachably coupled to the suction part 120. Further, the other end of the extension tube 200 may be detachably coupled to the suction module 300.

For example, the extension tube 200 may be formed in a long cylindrical shape. Therefore, an internal space of the extension tube 200 may communicate with an internal space of the cleaning module 300. In addition, the extension tube 200 may communicate with the suction flow path formed in the suction part 120 of the cleaner main body 100.

When the suction force is generated by the suction motor 140, the suction force may be provided to the suction module 300 through the suction part 120 and the extension tube 200. Therefore, outside dust and air may be introduced into the cleaner main body 100 through the cleaning module 300 and the extension tube 200. In addition, dust and air introduced through the suction module 300 may pass through the extension tube 200 and then be introduced into the cleaner main body 100. Further, the dust and air, which have been introduced into the cleaner main body 100 and have passed through the suction part 120, may be separated by the dust separating part 130, the dust may be stored in the outer casing 170, and the air may be discharged to the outside through the air discharge cover 150.

The suction module 300 may move along the floor surface and suck dust present on the floor surface. The suction module 300 may be connected to the cleaner main body 100 through the extension tube 200.

For example, the suction module 300 may have an agitator capable of guiding dust on the floor surface to the suction port while rotating. Alternatively, a rag (mop) may be further provided on the suction module 300 and configured to wipe the floor surface.

Meanwhile, although not illustrated, the suction module 300 may be connected directly to the cleaner main body 100 even without the extension tube 200.

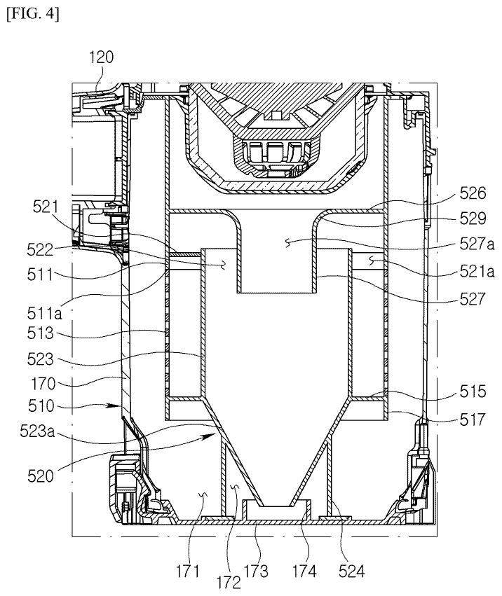

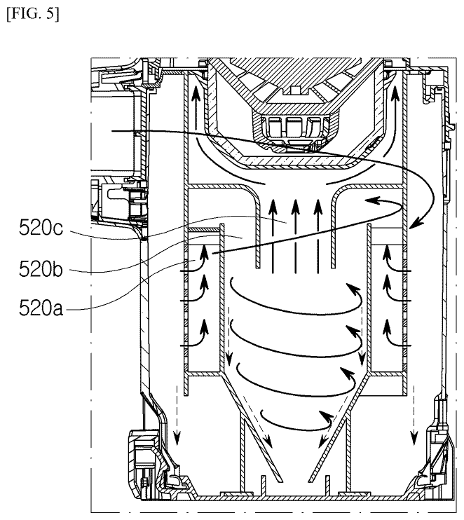

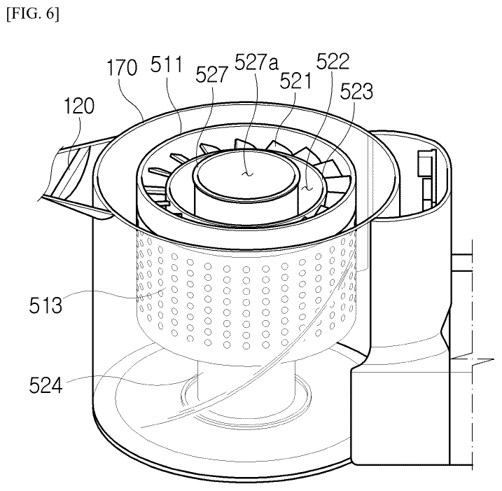

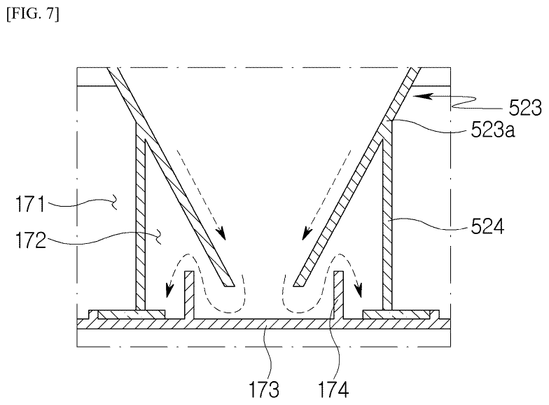

Meanwhile, FIG. 4 is an enlarged cross-sectional view of the dust separating part in FIG. 3, FIG. 5 is a cross-sectional view illustrating an airflow and a dust flow in FIG. 4, FIG. 6 is a cross-sectional view taken along line 6-6 in FIG. 3, and FIG. 7 is an enlarged view of a part of FIG. 3.

The dust separating part 500 of the cleaner according to the embodiment of the present disclosure will be described with reference to FIGS. 4 to 7.

The dust separating part 500 may be disposed rearward of the suction part 120 and disposed coaxially with the motor shaft of the suction motor 140. In addition, the dust separating part 500 and the suction motor 140 may be disposed in a direction of a central axis of the cyclone flow, and the dust separating part 500 may be disposed below the suction motor 140.

The dust separating part 500 may separate dust from the air by means of the cyclone flow formed therein. That is, the air, which is sucked by the suction force of the suction motor 140, may spirally flow in the dust separating part 500, and dust may be separated by a centrifugal force.

The dust separating part 500 may communicate with the flow path P1 formed in the suction part 120, such that air may be sucked through the suction part 120, and dust may be separated from the air sucked through the flow path P2 in the suction part 120 and discharged to the suction flow path P3 in the fan driving part.

In order to form the flow path P2 in the dust separating part 500, the dust separating part 500 may include the first cyclone part 510 configured to separate debris from the air sucked into the suction part 120, and the second cyclone part 520 configured to separate debris from the air having passed through the first cyclone part 510. In this case, central axes of primary and secondary cyclones formed in the dust separating part 500 may be disposed on the same axis and disposed to be perpendicular to the suction part 120.

The first cyclone part 510 may include the outer casing 170 configured to define an outer wall, a housing 511 configured to define an inner wall, and a mesh filter 513 disposed in the housing 511.

In order to form a cylindrical space in the outer casing 170, the outer casing 170 is formed in an approximately hollow cylindrical shape. Unlike an inner peripheral surface of the outer casing 170, an outer surface of the outer casing 170 defines an external appearance of the dust separating part 500 without having to be formed in a cylindrical shape.

The suction part 120 is disposed above the outer casing 170 and communicates with the outer casing 170, such that air and dust, which are introduced through the suction part 120, are introduced into the suction part 120. In this case, for example, the flow path Pl of the suction part 120 may be disposed in a direction tangential to the outer casing 170, and air and dust introduced through the suction part 120 may flow downward while rotating along the inner peripheral surface of the outer casing 170.

The outer casing 170 may be disposed below the main body housing 511. The outer casing 170 may be a part of the main body housing 511. The outer casing 170 may be provided in a form coupled to a lower portion of the main body housing 511. The outer casing 170 may be detachably coupled to the main body housing 511.

The outer casing 170 may be formed to be opened downward, and the discharge cover 173 may be detachably on a lower portion of the outer casing 170.

The housing 511 may be disposed in the outer casing 170 with a hollow space interposed between the housing 511 and the outer casing 170. The housing 511 may be integrated with the main body housing 511, formed in a hollow cylindrical shape, and disposed in the upward/downward direction. A central axis of the housing 511 may be disposed on a central axis of the inner peripheral surface of the outer casing 170.

In addition, the housing 511 has the mesh filter 513 and allows the air to flow to the second cyclone part 520.

The housing 511 and the mesh filter 513 may be provided in a separable or integrated configuration. In the case of the separable configuration, the housing 511 may have at least one hollow portion 511a so that at least one mesh filter 513 is installed. In this case, an inlet portion 521a to be described below may be defined by an inner peripheral surface in which the hollow portion 511a of the housing 511 is not formed. A guide vane 521 to be described below may also be provided on the inner peripheral surface in which the hollow portion 511a of the housing 511 is not formed.

The hollow portion 511a may be provided as a plurality of hollow portions 511a provided in the housing 511 and spaced apart from one another at equal intervals in the circumferential direction. In the case of the integrated configuration, the housing 511 may have the cylindrical mesh filter 513 formed in a mesh or porous shape having a plurality of air passing holes formed in a partial section thereof. In this case, the inlet portion 521a to be described below may be defined by an inner peripheral surface in which the air passing hole is not formed in the housing 511. The guide vane 521 to be described below may also be provided on the inner peripheral surface in which the hollow portion 511a of the housing 511 is not formed.

The mesh filter 513 may have a mesh or porous shape to separate dust from the air introduced into the outer casing 170, and the size criterion for distinguishing between dust and fine dust may be determined by the mesh filter 513. For example, dust cannot pass through the mesh filter 513, and fine dust may pass through the mesh filter 513.

The air may perform a swirling flow between the outer casing 170 and the housing 511 by the primary cyclone flow, a rotational force may decrease, and the air may pass through the mesh filter 513 and flow into the housing 511. Further, dust may be separated from the air as the air performs the primary cyclone flow, and dust may be separated from the air once more as the air passes through the mesh filter 513. The dust may fall into the first dust collecting portion 171.

The second cyclone part 520 may include a cylinder 523 configured to define an outer wall, a discharge member 527 configured to define an inner wall in the cylinder 523, and the inlet portion 521a disposed outside the cylinder 523.

In particular, in the second cyclone part 520, a first flow path 520a, through which air flows toward the suction motor 140, a second flow path 520b, through which air flows toward a side opposite to the suction motor 140, and a third flow path 520c, through which air flows toward the suction motor 140, may be connected to form a secondary cyclone flow.

The cylinder 523 may be formed in a hollow cylindrical shape and disposed in the housing 511, and the cylinder 523 may define a hollow space between the cylinder 523 and the housing 511. The cylinder 523 may be integrated with the housing 511 by means of an auxiliary wall 515. For example, the auxiliary wall 515 may be provided in the form of a hollow circular plate, an outer peripheral surface of the auxiliary wall 515 may be integrated with the housing 511, and an inner peripheral surface of the auxiliary wall 515 may be integrated with the cylinder 523. The auxiliary wall 515 seals a lower side of the hollow space between the housing 511 and the cylinder 523 so that air having passed through the mesh filter 513 may flow upward. In addition, in order to improve the dust separation performance, the housing 511 may have an extension end portion 517 protruding downward from the auxiliary wall 515.

The inlet portion 521a is disposed in the hollow space between the housing 511 and the cylinder 523 and disposed above the mesh filter 513. The inlet portion 521a is a space disposed above the mesh filter 513 and formed as a boundary between the housing 511 and the cylinder 523. The inlet portion 521a is disposed outside the cylinder 523 and allows air to flow to the suction motor 140, and the guide vane 521 is installed to induce a swirling flow in the air.

In this case, the air ascends in the inlet portion 521a, and the air descends in a separation space 522 to be described below, such that the air in the inlet portion 521a and the air in the separation space 522 may flow in opposite directions.

The guide vane 521 may be installed in the inlet portion 521a and include a plurality of blades each having a spiral shape. That is, the guide vane 521 may be formed in a spiral shape and extend from an inner peripheral surface of the housing 511 to an outer peripheral surface of the cylinder 523.

Therefore, the guide vane 521 may be disposed on the outer peripheral surface of the cylinder 523, and an inner peripheral surface of the cylinder 523 may define the hollow separation space 522. That is, the guide vane 521 is disposed on the outer peripheral surface of the cylinder 523, and the guide vane 521 is not disposed on the inner peripheral surface of the cylinder 523. Further, because the guide vane 521 does not need to be installed on the inner peripheral surface of the cylinder 523, the separation space 522, which is relatively larger, may be ensured in comparison with the case in which the guide vane 521 is disposed on the inner peripheral surface of the cylinder 523. In addition, the guide vane 521 may be provided only on the outer surface of the inner and outer peripheral surfaces of the cylinder 523, such that an air inlet space and an air outlet space may be enlarged. That is, because the guide vane 521 is disposed outside the cylinder 523, a rotation radius of the air swirling flow may be increased, and the dust separation performance may be improved.

In addition, the guide vane 521 may be disposed adjacent to an end of the cylinder 523 adjacent to the suction motor 140, or the guide vane 521 may be disposed at the end of the cylinder 523 adjacent to the suction motor 140. That is, the guide vane 521 is disposed such that an upper end thereof is adjacent to or consistent with an upper end of the cylinder 523, and the guide vane 521 guides the airflow.

In this case, the air having passed through the guide vane 521 may flow to a space between the upper end of the cylinder 523 and a separation wall 526 to be described below without resistance, such that the air may be naturally guide. In addition, the air having passed through the guide vane 521 may flow directly to the space between the upper end of the cylinder 523 and the separation wall 526 to be described below, thereby maintaining the swirling flow.

The housing 511 may have the separation wall 526 configured to separate the flow path P2 in the dust separating part 500 and the flow path P3 in the fan driving part. The separation wall 526 may be disposed between the cylinder 523 and the suction motor 140 and have the discharge member 527.

The separation wall 526 may define a boundary between the flow path P2 in the dust separating part 500 and the flow path P3 in the fan driving part, and the air, from which dust is separated by the dust separating part 500, is discharged to the flow path P3 in the fan driving part through the discharge member 527.

The separation wall 526 may be disposed in the housing 511 in a direction intersecting the cylinder 523. For example, the separation wall 526 may be disposed to be perpendicular to the cylinder 523. The separation wall 526 may protrude from the inner peripheral surface of the housing 511 and be provided in the form of a hollow plate. Further, a hole formed in the separation wall 526 is a discharge port 527a.

The separation wall 526 may be disposed to be spaced apart forward from the upper end of the cylinder 523, and the air may flow through the space between the separation wall 526 and the upper end of the cylinder 523 and flow into the cylinder 523.

The separation wall 526 may have the discharge member 527 having the discharge port 527a protruding downward. A curved connection portion 529 may be formed between the separation wall 526 and the discharge member 527 and have a diameter that gradually decreases downward.

The discharge member 527 may protrude from the separation wall 526 and be formed in a hollow cylindrical shape, and the discharge member 527 may be disposed in the cylinder 523 and configured to discharge the air from which dust is separated.

Further, the second cyclone part 520 has the separation space 522 provided between the cylinder 523 and the discharge member 527 and having a hollow shape. The separation space 522 is formed as an empty space, such that the air flows downward while freely performing a swirling flow and flows into the cylinder 523.

In addition, in the second cyclone part 520, the inlet portion 521a is disposed outside the separation space 522, and the discharge port 527a is disposed inside the separation space 522, such that the inlet portion 521a and the discharge port 527a may be completely separated spatially. Therefore, it is possible to solve the problem in which the air flows directly to the discharge port 527a immediately after the air is introduced through the inlet portion 521a, and dust is discharged to the outside together with the air without being separated.

In addition, the air is raised by the secondary cyclone flow while performing a swirling flow through the inlet portion 521a, guided by the separation wall 526, and then lowered while performing the swirling flow again, and then the air is inverted, flows upward, and is discharged through the discharge member 527. Further, dust may be separated from the air as the air performs the secondary cyclone flow, and the dust may fall into the second dust collecting portion 172.

The secondary cyclone flow may be implemented by the first flow path 520a, the second flow path 520b, and the third flow path 520c.

With reference to FIGS. 4 and 5, the first flow path 520a includes an internal space of the inlet portion 521a that is a space defined by the housing 511 and the cylinder. When an imaginary cylinder made by extending an end of the cylinder 523 to the separation wall 526 is drawn, a hollow space between the imaginary cylinder and the housing 511 may be the first flow path 520a. The air may pass through the mesh filter 513 and then be introduced into the first flow path 520a, and the air may flow to the suction motor 140 while rotating in the first flow path 520a and collide with the separation wall 526. In this case, some fine dust may be separated while the air collides with the separation wall 526.

The second flow path 520b includes a stagnation space 522 that is a space defined by the cylinder 523 and the discharge member 527. When an imaginary cylinder made by extending the end of the cylinder 523 to the separation wall 526 is drawn, the second flow path 520b may be formed in the cylinder 523. The second flow path 520b includes a space between the imaginary cylinder and the discharge member 527. The air flows through the first flow path 520a, collides with the separation wall 526, and then flows into the second flow path 520b. The air is separated from fine dust while flowing to the side opposite to the suction motor 140 while rotating through the second flow path 520b.

The third flow path 520c may be formed inside the second flow path 520b and include an internal space of the discharge member 527. The air flows through the second flow path 520b. When the rotational force decreases, the air is introduced into the third flow path 520c. The air performs a swirling flow through the third flow path 520c by a suction force of the suction motor 140 and flows to the suction motor 140 through the discharge member 527.

As a result, the flow path P2 in the dust separating part 500 according to the embodiment will be described. The air introduced through the suction part 120 may perform the primary cyclone flow between the outer casing 170 and the housing 511, pass through the mesh filter 513, and flow into the housing 511. Further, the air having passed through the mesh filter 513 may pass through the inlet portion 521a while being raised by the auxiliary wall 515 and the cylinder 523. The air performs the secondary cyclone flow while passing through the inlet portion 521a, and the air flows through the first flow path 520a, the second flow path 520b, and the third flow path 520c. That is, the air flows upward while inducing a swirling flow while passing through the inlet portion 521a, and the air is guided by the separation wall 526 and descends in the separation space 522. Further, dust is separated as the air performs a swirling flow in the cylinder 523, and the air may flow to the flow path P3 in the fan driving part through the discharge member 527.

In this case, the air flows upward while performing the swirling flow from the inlet portion 521a into the cylinder 523 and then flows downward again, such that the flow path is lengthened. Further, when the air is introduced between the cylinder 523 and the discharge member 527, the air may be introduced first while maintaining the applied swirling flow while passing through the inlet portion 521a, thereby improving the dust separation performance.

In addition, the guide vane 521, the separation space 522, and the discharge port 527a may be disposed in a radial direction and disposed in the radial direction at the same height based on when the outer casing 170 is placed on the ground surface.

Meanwhile, the outer casing 170 may be formed to store dust separated from the air and have the first dust collecting portion 171 configured to collect dust separated by the first cyclone part 510, and the second dust collecting portion 172 configured to collect dust separated by the second cyclone part 520.

The first dust collecting portion 171 and the second dust collecting portion 172 may be formed at a lower side of the inside of the outer casing 170, and a region is divided and separated by a separation member 524. The first dust collecting portion 171 and the second dust collecting portion 172 may be opened downward when the discharge cover 173 opens the outer casing 170. The first dust collecting portion 171 and the second dust collecting portion 172 may simultaneously discharge the dust collected in the first dust collecting portion 171 and the dust collected in the second dust collecting portion 172.

For example, the separation member 524 may be formed in a hollow cylindrical shape and integrated with the cylinder 523. Further, the space defined between the outer casing 170 and the separation member 524 may be the first dust collecting portion 171, and the internal space of the separation member 524 may be the second dust collecting portion 172.

In addition, the cylinder 523 may have a tapered portion 523a having a diameter that decreases downward from a portion connected to the auxiliary wall 515. Dust may be separated from the air along the tapered portion 523a and fall into and be collected in the second dust collecting portion 172 along the tapered portion 523a.

Further, the cylinder 523 may have the separation member 524 configured to surround a lower portion of the tapered portion 523a and protruding downward from one side of the tapered portion 523a, and the separation member 524 may have a cylindrical shape having a predetermined diameter.

In this case, a lower end of the separation member 524 may protrude further than a lower end of the tapered portion 523a. That is, an interval between the lower end of the separation member 524 and the discharge cover 173 may be smaller than an interval between the lower end of the tapered portion 523a and the discharge cover 173. Alternatively, the lower end of the separation member 524 may be formed to be in contact with the discharge cover 173, and the lower end of the tapered portion 523a may be formed to be spaced apart from the discharge cover 173 at a predetermined interval.

In addition, the discharge cover 173 may have a rib 174 protruding toward the cylinder 523 and having a hollow cylindrical shape. The rib 174 may be disposed between the lower end of the tapered portion 523a and the separation member 524 and formed to surround the lower end of the tapered portion 523a. Further, the lower end of the tapered portion 523a may be disposed inside the rib 174.

The rib 174 may be formed to be spaced apart from the tapered portion 523a at a predetermined interval, such that dust, which falls along the tapered portion 523a, may be collected inside the rib.

As described above, the rib 174, the lower end of the tapered portion 523a, and the separation member 524 are disposed to overlap one another, thereby minimizing a degree to which the dust collected in the second dust collecting portion 172 moves to the first dust collecting portion 171, and minimizing resistance caused when the discharge cover 173 opens or closes the outer casing 170.

With reference to FIG. 7, the dust, which has passed over the lower end of the tapered portion 523a, needs to climb over the rib 174 to move into the separation member 524. Because the separation member 524 is kept in contact with the discharge cover 173, the dust cannot move to the first dust collecting portion 171.

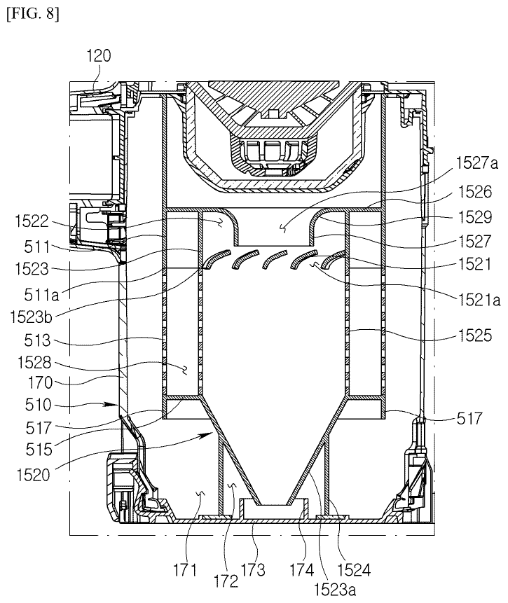

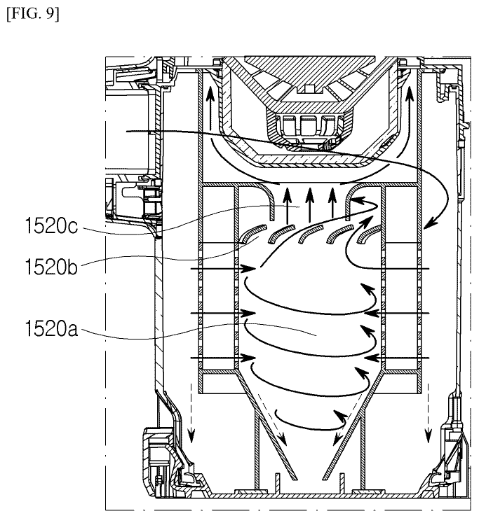

Meanwhile, FIG. 8 is a cross-sectional view of a cleaner according to another embodiment of the present disclosure, and FIG. 9 is a cross-sectional view illustrating an airflow and a dust flow in FIG. 8.

In order to avoid the repeated description, the description of the configuration and effect of the cleaner according to the embodiment of the present disclosure may be applied except for components described in the present embodiment.

In a second cyclone part 1520 according to the present embodiment, a guide vane 1521 is installed in a cylinder 1523 and installed to be spaced apart from a discharge member 1527 in an axial direction.

In addition, in the second cyclone part 1520, a first flow path 1520a, through which air flows toward the suction motor 140, a second flow path 1520b, through which air flows toward a side opposite to the suction motor 140, and a third flow path 1520c, through which air flows toward the suction motor 140, may be connected to form a secondary cyclone flow.

The cylinder 1523 is formed such that air penetrates an outer peripheral surface of the cylinder 1523 and is introduced into the cylinder 1523, and the air introduced into the cylinder 1523 ascends while passing through the guide vane 1521.

An upper end of the cylinder 1523 is formed to be connected to a separation wall 1526 and protrude downward from the separation wall 1526. A tapered portion 1523a may be provided at a lower side of the cylinder 1523 and configured to guide dust separated from the air by the cyclone flow, and a separation member 1524 may be provided to separate the first dust collecting portion 171 and the second dust collecting portion 172.

At least one sub-filter 1525 is installed in the cylinder 1523 to introduce air into the cylinder 1523. The cylinder 1523 and the sub-filter 1525 may be provided in a separable or integrated configuration. In the case of the separable configuration, the cylinder 1523 may have at least one filter insertion hole 1523b to which the sub-filter 1525 may be coupled. The filter insertion hole 1523b may be provided as a plurality of filter insertion holes 1523b provided in the cylinder 1523 and spaced apart from one another at equal intervals in the circumferential direction. In the case of the integrated configuration, the cylinder 1523 may have the cylindrical sub-filter 1525 may be formed as a partial section of the cylinder 1523 is formed in a mesh or porous shape.

In this case, the sub-filter 1525 may be installed to be opposite to the mesh filter 513. Water channels, which correspond in number to the mesh filters 513, may be installed. In addition, the sub-filter 1525 may have a mesh or porous shape and have air passing holes identical to the air passing holes of the mesh filter 513. Therefore, dust having passed through the mesh filter 513 may pass through the sub-filter 1525 and be introduced into the cylinder 1523.

The sub-filter 1525 is formed in a cylindrical shape and disposed with a hollow guide space 1528 interposed between the sub-filter 1525 and the mesh filter 513. The guide space 1528 may be a space formed between the mesh filter 513 and the sub-filter 1525. The guide space 1528 may guide the air so that the air may be introduced in the radial direction when the air is introduced into the cylinder 1523. Further, the air may be introduced into the cylinder 1523 in the radial direction while passing through the two filters 513 and 1525 and the guide space 1528 and flow to an inlet portion 1521a.

The inlet portion 1521a may be disposed in the internal space of the cylinder 1523 and disposed between the sub-filter 1525 and the discharge member 1527. The inlet portion 1521a is a space defined in the cylinder 1523 between the sub-filter 1525 and the discharge member 1527. More accurately, in the internal space of the cylinder 1523, a hollow peripheral portion of an internal space between the sub-filter 1525 and the discharge member 1527 may be the inlet portion 1521a through which the air having passed through the sub-filter 1525 flows, and the air, which is to pass through the discharge member 1527, may flow through a middle portion of the internal space.

The inlet portion 1521a allows the air to flow upward, and the guide vane 1521 is installed to induce the swirling flow in the air.

The guide vane 1521 may be installed in the inlet portion 1521a and protrude in a spiral shape from an inner peripheral surface of the cylinder 1523. The guide vane 1521 may include a plurality of blades each having one end provided in the form of a free end integrated with the inner peripheral surface of the cylinder 1523, and a cylindrical space in which the air, which is to pass through the discharge member 1527, may flow is provided inside the plurality of blades.

In particular, the guide vane 1521 may be provided in a spiral shape in a swirling direction of the air when the air performs the primary cyclone flow. A swirling flow may be induced in a swirling direction identical to the swirling direction of the air when the air passing through the guide vane 1521 performs the primary cyclone flow. That is, the swirling flow direction of the air during the primary cyclone flow may be identical to the swirling flow direction of the air during the secondary cyclone flow, and the primary cyclone flow may be maximally utilized, thereby improving the cyclone efficiency. However, the air may have the same swirling flow direction and flow upward or downward.

The guide vane 1521 guides the air so that the air, which flows upward in the inlet portion 1521a, flows upward while performing the swirling flow. In addition, the guide vane 1521 may be disposed inside the cylinder 1523 and disposed to be spaced apart from the discharge member 1527 along a central axis of the secondary cyclone flow.

That is, an end of the guide vane 1521 adjacent to the suction motor 140 is disposed to be spaced apart from an end of the discharge member 1527 opposite to the suction motor 140 along the central axis of the secondary cyclone flow. Alternatively, a length from the discharge cover 173 to an upper end of the guide vane 1521 is shorter than a length from the discharge cover 173 to a lower end of the discharge member 1527.

In addition, when an imaginary cylinder made by extending the discharge member 1527 to the discharge cover 173 is drawn, the imaginary cylinder and the guide vane 1521 are formed so as not to overlap or collide with each other.

The separation wall 1526 may have the discharge member 1527 formed as a discharge port 1527a protrudes, and a curved connection portion 1529 may be provided between the separation wall 1526 and the discharge member 1527 and have a diameter that gradually decreases downward.

Further, the second cyclone part 1520 has a stagnation space 1522 defined by the separation wall 1526, the curved connection portion 1529, the discharge member 1527, and the upper end of the cylinder 1523. The stagnation space 1522 is provided as a hollow shape having an empty space therein, and the air is guided by the separation wall 1526 and flows into the cylinder 1523. In this case, in the stagnation space 1522, the air, which flows from the inlet portion 1521a toward the separation wall 1526, ascends, and the air guided by the separation wall 1526 descends.

Meanwhile, the secondary cyclone flow may be implemented by the first flow path 1520a, the second flow path 1520b, and the third flow path 1520c.

With reference to FIGS. 8 and 9, the first flow path 1520a may be formed inside the cylinder 1523 and include an internal space of the inlet portion 1521a. The first flow path 1520a may be provided between the cylinder 1523 and the discharge member 1527, and the first flow path 1520a may be a space formed from a lower end of the guide vane 1521 to the separation wall 1526. The air may pass through the sub-filter 1525 and then be introduced into the first flow path 1520a, and the air may flow to the suction motor 140 while rotating in the first flow path 1520a and collide with the separation wall 1526. In this case, some fine dust may be separated while the air collides with the separation wall 1526.

The second flow path 1520b may be formed inside the first flow path 1520a between the cylinder 1523 and the discharge member 1527 and include the stagnation space 1522. The air flows through the first flow path 1520a, collides with the separation wall 1526, and then flows into the second flow path 1520b. The air is separated from fine dust while flowing to the side opposite to the suction motor 140 while rotating through the second flow path 1520b.

The third flow path 1520c may be formed inside the second flow path 1520b and include an internal space of the discharge member 1527. The air flows through the second flow path 1520b. When the rotational force decreases, the air is introduced into the third flow path 1520c. The air performs a swirling flow through the third flow path 1520c by a suction force of the suction motor 140 and flows to the suction motor 140 through the discharge member 1527.

As a result, the flow path P2 in the dust separating part 500 according to another embodiment will be described. The air introduced through the suction part 120 may perform the primary cyclone flow between the outer casing 170 and the housing 511. Further, the air is filtered twice while passing through the mesh filter 513, the guide space 1528, and the sub-filter 1525, and the air is introduced into the cylinder 1523 in the radial direction and performs the secondary cyclone flow. The air is introduced into the cylinder 1523 through the sub-filter 1525 while performing the secondary cyclone flow and flows toward the inlet portion 1521a. The air is rotated by the guide vane 1521 in the same swirling direction identical to the primary cyclone flow and flows upward. Further, the air flows from the inlet portion 1521a toward the separation wall 1526 and descends while being guided by the separation wall 1526, and then the air may be inverted, flow upward, and move to the flow path P3 in the fan driving part through the discharge member 1527.

While the specific embodiments of the present disclosure have been described and illustrated, it is obvious to those skilled in the art that the present disclosure is not limited to the aforementioned embodiments and may be variously changed and modified without departing from the spirit and the scope of the present disclosure. Therefore, the scope of the present disclosure should be determined by the technical spirit of the appended claims instead of being determined by the described embodiment.

1. A cleaner comprising:
a suction part having a flow path through which air flows;
a dust separating part configured to separate dust from air sucked through the suction part; and
a suction motor configured to provide a flow force of air,
wherein the dust separating part comprises:
a first cyclone part configured to separate debris from air sucked into the suction part; and
a second cyclone part configured to separate debris from air passing through the first cyclone part,
wherein the first cyclone part comprises a cylindrical housing in which a mesh filter is installed to allow the air to flow to the second cyclone part, and
wherein the second cyclone part comprises:
a cylinder disposed in the housing and having a guide vane configured to induce a swirling flow in the air;
a separation wall disposed between the cylinder and the suction motor in a direction intersecting the cylinder; and
a discharge member protruding from the separation wall, disposed in the cylinder, and formed to discharge the air.

2. The cleaner of claim 1, wherein the second cyclone part comprises:
a first flow path through which air flows toward the suction motor;
a second flow path through which air having passed through the first flow path flows to a side opposite to the suction motor; and
a third flow path through which air having passed through the second flow path toward the suction motor.

3. The cleaner of claim 1, wherein the second cyclone part has an inlet portion disposed between the housing and the cylinder and configured to allow the air to flow toward the suction motor.

4. The cleaner of claim 3, wherein the guide vane protrudes in a spiral shape from an outer peripheral surface of the cylinder and is installed in the inlet portion, and the guide vane is disposed adjacent to an end of the cylinder adjacent to the suction motor.

5. The cleaner of claim 1, wherein the second cyclone part has an inlet portion configured to allow the air in the cylinder to flow toward the suction motor, and
wherein the cylinder has a sub-filter connected to the separation wall and configured to introduce the air having passed through the mesh filter into the cylinder.

6. The cleaner of claim 5, wherein the guide vane protrudes in a spiral shape from an inner peripheral surface of the cylinder and is installed in the inlet portion, and
wherein an end of the guide vane adjacent to the suction motor is disposed to be spaced apart from an end of the discharge member opposite to the suction motor along a central axis of a secondary cyclone flow.

7. The cleaner of claim 5, wherein the sub-filter is formed in a cylindrical shape and disposed with a hollow guide space interposed between the sub-filter and the mesh filter.

8. The cleaner of claim 1, wherein a hollow separation space is provided between the cylinder and the discharge member.

9.
The cleaner of claim 1, wherein the dust separating part further comprises:
an outer casing connected to the suction part and configured such that the housing is disposed in the outer casing, the outer casing being configured to provide a dust collecting portion configured to store dust separated from the air; and
a discharge cover configured to open or close a lower side of the outer casing,
wherein a lower end of the cylinder has a tapered portion formed to be spaced apart from the discharge cover, and
wherein the discharge cover has a rib protruding toward the cylinder and configured to surround a lower end of the tapered portion.

10. A cleaner comprising:
a suction part having a flow path through which air flows;
a dust separating part configured to separate dust from air sucked through the suction part; and
a suction motor configured to provide a flow force of air,
wherein the dust separating part comprises:
a first cyclone part configured to separate debris from air sucked into the suction part; and
a second cyclone part configured to separate debris from air passing through the first cyclone part, and
wherein the second cyclone part comprises:
a first flow path through which air flows toward the suction motor;
a second flow path through which air having passed through the first flow path flows to a side opposite to the suction motor; and
a third flow path through which air having passed through the second flow path toward the suction motor.

11. A cleaner comprising:
a suction part having a flow path through which air flows;
a dust separating part configured to separate dust from air sucked through the suction part; and
a suction motor configured to provide a flow force of air,
wherein the dust separating part comprises:
a first cyclone part configured to separate debris from air sucked into the suction part; and
a second cyclone part configured to separate debris from air passing through the first cyclone part,
wherein the dust separating part has a mesh filter and a sub-filter disposed to be spaced apart from each other with a hollow guide space therebetween, and
wherein the air passes through the mesh filter and the sub-filter and flows to the second cyclone part.
